(19) United States
(12) Patent Application Publication
(10) Pub. No.: US 2008/0003325 A1
(43) Pub. Date: Jan. 3, 2008

(54) BAFFLE FOR MOLD COOLING SYSTEMS

(76) Inventor: Richard T. Seaver, Montague, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/771,199

(22) Filed: Jun. 29, 2007

Related U.S. Application Data
(60) Provisional application No. 60/818,104, filed on Jun. 30, 2006.

(51) Int. Cl. B29C 45/00; A23P 1/00

(52) U.S. Cl. 425/552

(57) ABSTRACT

A baffle for cooling passageways of injection mold tools and the like is made of a polymer material, and includes a divider having a H-shaped cross section with outer surface portions that fit closely against or adjacent cylindrical surfaces of cooling passageways to center the baffle in the passageway arid substantially prevent flow of fluid around the sides of the divider. The baffle may include a plurality of indicia on the divider indicating the length of the divider to permit the length of the baffle to be cut to size to fit a cooling passage of a particular mold tool being constructed.

### CROSS-REFERENCE TO RELATED APPLICATIONS

This application claims the benefit of U.S. Provisional Patent Application No. 60/818,104, filed on Jun. 30, 2006, the entire contents of which are incorporated herein by reference.

### BACKGROUND OF THE INVENTION

Mold tools for forming plastic parts and the like typically include first and second mold parts that close to form a cavity into which molten plastic is injected. The mold parts typically operate at high temperatures, such that cooling passages or the like are required to control the temperature of the mold. Such cooling systems typically include one or more fluid passageways through the mold parts, and coolant. (e g., water) is introduced from an external source into the passageways to thereby cool the mold part.

Certain parts to be molded may require that one or both of the mold parts include a protrusion or extension having a mold cavity surface on the protrusion. Such protrusions often require cooling, yet a straight passageway for flow through of coolant cannot be drilled into the protrusion without breaking through the mold surface at the mold cavity.

Various arrangements have been developed for cooling such protrusions. Typically, a blind hole is drilled into tie protrusion from an outer side of the mold part, with the drill stopping short of breaking through the mold cavity surface of the protrusion. A cross passageway is then drilled through the mold part, and a baffle is inserted into the blind hole to thereby cause the coolant to flow around the baffle in the blind hole to cool the protruding portion of the mold part. One type of baffle is made of metal, and it may be a flat blade or it may be spiraled to center the baffle in the blind hole. However, known metal baffles suffer from several drawbacks. The flat blade type metal baffles may not stay centered in the hole. Although spiral metal baffles are self-centering, spiral baffles are significantly more expensive than the flat blade metal baffles.

Accordingly, a baffle alleviating the problem is associated with known baffles would be advantageous.

### BRIEF DESCRIPTION OF THE DRAWINGS

FIG. 1 is a partially schematic cross-sectional view of a mold tool including a baffle according to one aspect of the present invention;

FIG. 2 is a front elevational view of a baffle for cooling passages in mold tools according to the present invention;

FIG. 3 is an isometric view of the baffle of FIG. 2;

FIG. 4 is an end view of the baffle of FIG. 3, taken along the line IV-IV; FIG. 3;

FIG. 5 is an end view of the baffle of FIG. 3, taken along the line V-V; FIG. 3.

### DETAILED DESCRIPTION OF PREFERRED EMBODIMENT

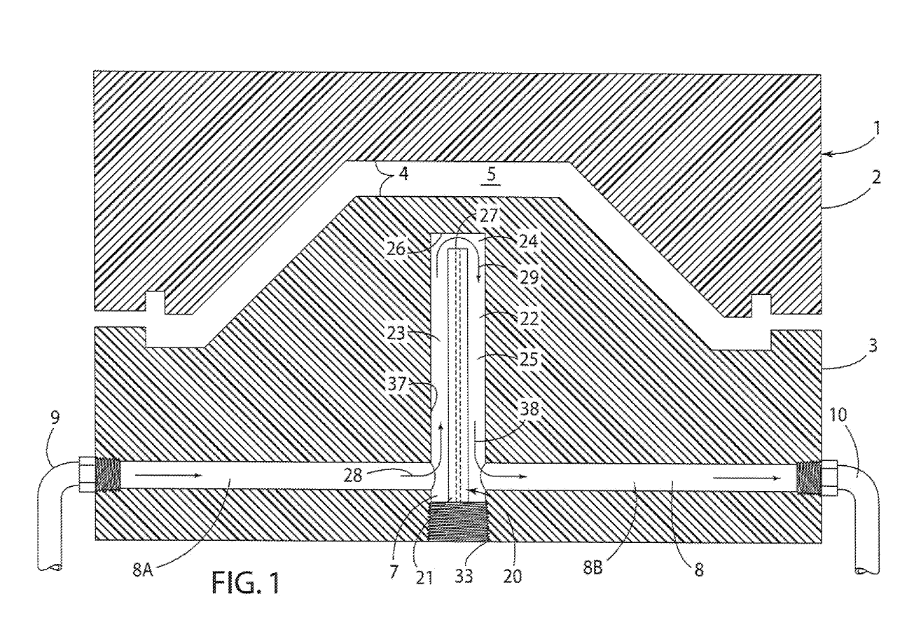

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts. Hence, specific dimensions and other physical characteristics relating to the embodiments disclosed herein are not to be considered as limiting.

With reference to FIG. 1, a mold tool 1 includes a first part or “half” 2 and a second “half” 3, each including mold surfaces 4 that form a mold cavity 5 when the mold halves 2 and 3 are brought together. Mold part 3 includes a protrusion 6 into which a blind hole 7 is formed by drilling or the like. The blind hole 7 is fluidly connected to a cross passageway 8 having a first portion 8A upstream of blind hole 7, and a second portion 8B that is downstream of blind hole 7. An inlet line 9 supplied coolant such as water, or a mixture of water and other ingredients to the passageway 8, and an outlet line 10 provides for flow of coolant fluid out of second half 3 of mold tool 1. In the illustrated example, blind hole 7 is substantially larger in diameter than cross passageway 8. In general, the blind hole 7 may have a diameter that is at least about twice the diameter of the passageway 8.

Baffle 20 includes a divider 21 that extends into blind hole 7, thereby forming an elongated U-shaped passageway 22 including an elongated first portion 23, an end portion 24, and a second elongated portion 25. Coolant from inlet line 9 flows from first portion 8A of passageway 8 towards the end 26 of blind hole 7 along first portion 23 as indicated by the arrow 28, around end portion 24 of U-shaped passageway 22 formed by end 27 of divider 21 of baffle 20 and bottom 26 of blind hole 7. The flow of the coolant through end portion 24 of U-shaped passageway 22 is indicated by the arrow 29. The coolant fluid then flows along second portion 25 of U-shaped passageway 22 as indicated by the arrow 30, and then along portion 8B of cross passageway 8 to outlet line 10.

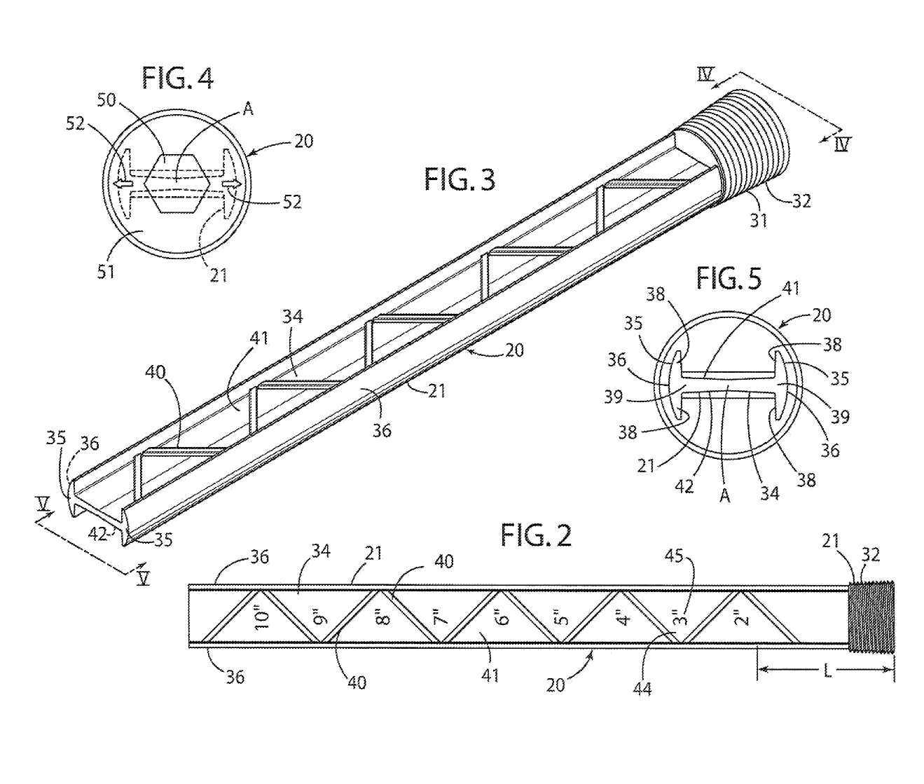

With reference to FIGS. 2-5, baffle 20 includes a threaded base portion 31 with external pipe threads 32 that sealingly engage threaded portion 33 (FIG. 1) of blind hole 7. Divider 21 of baffle 20 is integrally formed with threaded base portion 31, and has a generally H-shaped cross section (FIG. 5) formed by a web 34 and transverse flange-like end portions 35. Flange-like end portions 35 include an outer -surface 36 having a constant radius about axis “A” (FIG. 5) of divider 21. Surfaces 36 therefore take the form of a portion of a cylinder that fits closely against cylindrical sidewall surface 37 (FIG. 1) of blind hole 7 to thereby substantially prevent flow of coolant between outer surface 36 and cylindrical sidewall surface 37, and also to support and center divider 21 in blind hole 7. The cylindrical outer surface portions 36 have about the same radius as does cylindrical sidewall surface 37 of blind hole 7, such that baffle 20 can be rotated during installation to engage threaded base portion 31 of baffle 20 with threaded portion 33 of blind hole 7, yet also substantially block flow of coolant fluid between cylindrical surface portions 36 of divider 21 and cylindrical sidewall surface 37 of blind hole 7, End portions 35 include oppositely-extending flange portions 38 (FIG. 5) that extend away from an end portion 39 of web 34.

Baffle 20 may include plurality of raised, angled ridges 40 that protrude from opposite side surfaces 41 and 42 of web 34. The raised ridges 40 generate turbulence and/or increase the amount of turbulence in the coolant fluid as it travels through U-shaped passage 22 to thereby increase the transfer of heat from the mold tool to the coolant fluid. Also, in contrast to metal baffles, side surfaces 41 and 42 are textured to provide a rough surface to further generate and/or increase turbulence. In the illustrated example, side surfaces 41 and 42 are formed in a mold having rough surface known as an EDM 250 finish. This mold surface causes baffle surfaces 41 and 42 to have an appearance similar to 100 or 200 grit sand paper. This appearance is substantially different than that of prior metal baffles having a smooth surface, and the difference is immediately noticeable to the naked eye. It will be readily apparent that various surface features such as bumps, ridges, dimples, irregularities or the like could be formed in surfaces 41 and 42 to promote turbulence.

A plurality of lines or other indicia 44 may be formed on divider 21 of baffle 20, and indicia 45 (e.g., “1.0 inch”, “2.0 inches”, and/or “1.0 cm”, “2.0 cm”, etc.) provide a visual indication of the overall length “L” (FIG. 2) of baffle 20. Baffle 20 is preferably made of a molded glass fiber filled PPS (Poly Phenylene Sulfide), such as Ryton®. This material is very durable and resistant to degradation from heat in the range commonly encountered in injection molds and the like. Also, the divider 21 can be trimmed to the proper length by using snips or a knife to score or cut the ends of flanges 38. The divider 21 can then be bent (by hand) to break off an end portion of divider 21. Alternately, hand-saws, snips or other hand tools, or a powered saw or the like may be used to cut divider 21 to the proper length. In use, the depth of the blind hole 7 can be measured by inserting divider 21 into hole 7 until it hits bottom 26 of hole 7. The depth of the hole can then be determined by referring to indicia 44 and 45. The length of the baffle 20 can then be cut to the proper length by an individual by referring to the indicia 45 on divider 21. With reference to FIG. 4, base portion 31, of baffle 20 includes a hex cavity 50 or other suitable structure or the like that provides for rotation of baffle 20 during installation to tightly engage external pipe threads 32 of baffle 20 with internal threads 33 of blind opening 7. End surface 51 may include recessed areas 52 forming arrows or other indicia that permit the person installing baffle 20 to determine the orientation of the web 34 of divider 21.

In general, the coolant passages of mold tools vary from one mold tool to the next, such that a large number of differently-sized baffles are required if conventional metal baffles are utilized. This results in substantially increased cost due to the large number of baffle sizes that must be fabricated and kept in stock. However, the baffle 20 of the present invention can be quickly and easily out or trimmed to the required length for installation on a particular mold tool.

Also, the unique shape of the baffle of the present application centers the baffle in the cooling passageway, without requiring a spiral construction or the like. Also, because the baffle 20 is molded in one-piece, it can be fabricated in a very cost-effective manner. Various polymer materials or the like may be utilized to fabricate battle 20, and it will be understood that the Ryton® PPS material is merely one example of a suitable material. Also, it will be understood that the polymer need not be reinforced with glass fibers provided the material has sufficient strength characteristics for the particular application.

In the foregoing description, it will be readily appreciated by those skilled in the art that modifications may be made to the invention without departing from the concepts disclosed herein.

The invention claimed is:

1. A baffle for diverting fluid flow through an internal passageway of a mold tool, the baffle comprising:
an elongated divider having external tapered pipe threads at a first end, the divider including a central web with opposite edge portions, each opposite edge portion having flanges extending transverse to the central web, the central web and the flanges together forming an H-shape in cross section, and wherein the flanges define outer curved surfaces that are shaped to be closely disposed adjacent an inner surface of a cylindrical bore in a mold part.

2. The baffle of claim 1, wherein:
the divider defines an axis, and the outer curved surfaces define a constant radius with respect to the axis.

3. The baffle of claim 1, wherein:
the flanges define base portions having a first thickness adjacent the opposite edge portions of the central web, and wherein the flanges taper to define distal edges having a second thickness that is substantially less than the first thickness.

4. The baffle of claim 3, wherein:
the flanges define inner surfaces opposite the outer surfaces, and wherein the inner surfaces are substantially planar.

5. The baffle of claim 1, wherein:
the central web defines opposite side faces that are generally flat.

6. The baffle of claim 5, wherein:
the opposite side faces include planar surface portions.

7. The baffle of claim 6, wherein:
the opposite side faces include a plurality of protrusions extending outwardly from the planar surface portions to promote turbulent fluid flow along the divider.

8. The baffle of claim 5, wherein:
the opposite side faces have rough surface portions.

9. The baffle of claim 1, wherein:
the baffle includes indicia along the divider providing a visual indication of the length of the divider at the location of the indicia.

10. The baffle of claim 9, wherein:
the indicia comprises numbers.

11. The baffle of claim 1, wherein:
the baffle comprises a one-piece unitary member that is made of a polymer material.

12. The baffle of claim 1, wherein:
the baffle includes indicia at the first end enabling a user to determine an orientation of the central web when the baffle is threadably engaged in an opening of a component of a mold tool.

13. The baffle of claim 1, wherein:
the central web defines opposite side faces, and wherein the opposite side faces include a plurality of raised ridges extending diagonally across the side faces.

14. A mold tool, comprising:
at least two mold components wherein at least one of the mold components includes a first bore forming a passageway for coolant fluid extending through the one mold component having an inlet to the passageway at a first end of the passageway, and an outlet at a second end of the passageway, the one mold component having a second bore extending transverse to the first bore and intersecting the first bore, wherein the second bore comprises a blind hole having a single opening at a first end, and a bottom surface closing off a second end of the second bore, wherein the second bore includes tapered pipe threads at the first end; and
a baffle disposed in the second bore and dividing the second bore into first and second fluid passageways, the baffle including an elongated divider having external tapered pipe threads at a first end, the divider including a central web with opposite edge portions, each opposite edge portion having flanges extending transverse to the central web, the central web and the flanges together forming an H-shape in cross section, and wherein the flanges define outer surfaces disposed adjacent an inner surface of the second bore.

15. The mold tool of claim 14, wherein:
the divider defines an axis, and the outer surfaces are curved and define a constant radius with respect to the axis.

16. The mold tool of claim 15, wherein:
the flanges define base portions having a first thickness adjacent the opposite edge portions of the central web, and wherein the flanges taper to define distal edges having a second thickness that is substantially less than the first thickness.

17. The mold tool of claim 14, wherein:
the central web defines opposite side faces that are generally flat.

18. The mold tool of claim 17, wherein:
the opposite side faces include planar surface portions.

19. The mold tool of claim 18, wherein:
the opposite side faces include a plurality of protrusions extending outwardly from the planar surface portions to promote turbulent fluid flow along the divider.

20. The mold tool of claim 19, wherein:
the protrusions comprise raised ridges extending inwardly from the flanges at about a forty-five degree angle relative to the outer surfaces of the flanges.

21. The mold tool of claim 14, wherein;
the baffle comprises a one-piece unitary member that is made of a polymer material.

22. A baffle for mold tools of the type having cylindrical internal passageways for liquid coolant, the baffle comprising:
an elongated one-piece polymer member having an elongated divider wall defining first and second ends and opposite edge portions, the opposite edge portions having transverse protrusions configured to fit closely along a cylindrical surface of an internal passage-way in a mold tool, the one-piece polymer member further including a threaded portions at the first end for engaging a threaded portion of an internal passageway to mount the baffle in a mold tool.

23. The baffle of claim 22, wherein;
the divider wall defines generally flat opposite side faces.

24. The baffle of claim 23, wherein:
the opposite side faces include flat surface portions and a plurality of protrusions extending outwardly from the flat surface portions.

25. The baffle of claim 23, including:
indicator on the first end providing a visual representation of the orientation of the divider wall.

26. The baffle of claim 22, wherein:
the transverse protrusions comprise flanges extending in opposite directions from the opposite edge portions to define a H-shaped cross sectional shape.

27. The baffle of claim 26, wherein:
the flanges have curved outer surfaces forming a portion of a cylinder.
